(19) United States
(12) Patent Application Publication
(10) Pub. No.: US 2020/0318425 A1
(43) Pub. Date: Oct. 8, 2020

(54) RETROFIT SECURITY GRID FOR WINDOW

(71) Applicant: David Daniel Rankin, SR., Yadkinville, NC (US)

(72) Inventor: David Daniel Rankin, SR., Yadkinville, NC (US)

(21) Appl. No.: 16/375,273

(22) Filed: Apr. 4, 2019

(51) Int. Cl. E06B 9/01; G09F 23/00

(52) U.S. Cl. CPC E06B 9/01; E06B 2009/015; G09F 23/00

(57) ABSTRACT

A window security grid having two mounting plates adapted for being attached to a door and positioned on opposite side edges of a window in a door, a plurality of spaced-apart rails adapted to span a distance between the mounting plates and having an opposing end of each rail adapted for being connected to one of the mounting plates and at least one decorative feature connected to at least one of the rails.

### TECHNICAL FIELD AND BACKGROUND OF THE INVENTION

This invention relates to a window security grid for use on a window on or near a door to prevent access to an unwelcome intruder. Specifically, this invention relates to windows at or near doors in schools, such as classroom or library doors, as well as doors in other public and commercial buildings.

School shooting events have garnered wide publicity in recent years. In some tragic events, students were trapped inside classrooms, unable to bar entry to an intruder. This concern has spurred discussion and media attention about protecting students in the classroom. One such avenue of discussion revolves around teachers and students securing themselves inside of classrooms.

Many of these classroom doors have glass windows on or near them that can be broken and provide possible entry for an intruder, even doors that are locked or otherwise secured. An intruder bypassing the window glass would have the ability to reach into the classroom and directly cause harm to those inside with a weapon or reach inside and unlock the classroom door.

Often, it is not desirable to replace the classroom doors with windowless classroom doors from both a financial standpoint and a safety/security standpoint. The costs associated with replacement can be prohibitive for schools with tight budgets. From a safety and security standpoint local fire codes could prevent the outright removal of a window. Furthermore, windowless doors prevent those inside from determining who is trying to gain access to a classroom prior to opening the door, which in of itself is a security issue.

There is a need for a device that can prevent an intruder from bypassing the window glass of a classroom door.

### SUMMARY OF THE INVENTION

It is therefore an object of the present invention to provide a window security grid that prevents an intruder from reaching through a window when the window glass is shattered.

It is another obj ect of the present invention to provide for low cost and quickly installed window security grid.

These and other objects and advantages of the present invention are achieved in the preferred embodiments set forth below by providing a window security grid having two mounting plates adapted for being attached to a door and positioned on opposite side edges of a window in a door, a plurality of spaced-apart rails adapted to span a distance between the mounting plates and having an opposing end of each rail adapted for being connected to one of the mounting plates and at least one decorative feature connected to at least one of the rails.

According to another embodiment, the mounting plates extend along an entire length of the respective window side edges.

According to another embodiment, a plurality of fastening members is adapted to secure the mounting plates to the door

According to another embodiment, the fastening members are selected from the group consisting of: bolts, threaded bolts, screws, nails, and brackets.

According to another embodiment, a plurality of fastening members is adapted to secure the mounting plates to the door through a plurality of preformed holes in the mounting plates.

According to another embodiment, the fastening members are threaded bolts which pass through the hole in the mounting plate and into the door.

According to another embodiment, the rails are oriented perpendicular to the mounting plates.

According to another embodiment, the rails are adapted to be adjusted along a length of the mounting plates.

According to another embodiment, at least one of the rails includes a bracket positioned on one side of the rail adapted for attachment to corresponding protruding members located on each mounting plate for connecting the rail to the mounting plates.

According to another embodiment, the decorative features are releasably attached to the rails by magnets.

According to another embodiment, the decorative features include brackets adapted to be positioned on the rails.

According to another embodiment, two mounting back plates are adapted for being attached to the door on an opposite side with respect to the mounting plates and positioned on corresponding opposite side edges of the window, and a plurality of elongate fasteners are adapted to pass through the door and secure the mounting plates to the respective back plates.

According to another embodiment, a window security grid is provided having first and second mounting plates adapted for being positioned on opposite side edges of a window in a door and adapted to extend along an entire length of respective side edges of the window, a plurality of spaced-apart rails oriented perpendicular to the mounting plates, adapted to span a distance between the mounting plates, and opposite ends of each rail adapted for being connected to one of the mounting plates, and a plurality of fastening members adapted to secure the mounting plates to the door through a plurality of holes in the mounting plates.

According to another embodiment, a window security grid is provided having a frame formed of a plurality of spaced-apart mounting plates and a plurality of spaced-apart rails oriented perpendicular to the mounting plates to collectively define the grid, the grid having width and length dimension sized to fit within the width and length dimensions of a window positioned in a door, a plurality of fastening members adapted to secure the grid to the door and over the window, and a plurality of attachment members carried by the grid for receiving decorative or informational items.

According to another embodiment, the mounting plates and rails are integrally formed.

According to another embodiment, the mounting plates and rails are individually formed for assembly to form the grid upon installation onto the door over the window.

### BRIEF DESCRIPTION OF THE DRAWING FIGURES

The present invention is best understood when the following detailed description of the invention is read with reference to the accompanying drawings, in which:

FIG. 1 is a front view showing a window security grid mounted on a window;

FIG. 2 is a front view showing the grid in FIG. 1 on a door;

FIGS. 3-5 are front views showing the grid of FIG. 1 having alternative decorative features;

FIG. 6 is a back view showing an alternative embodiment of the grid installed through the door;

FIG. 7 is a partial exploded perspective view showing an alternative embodiment of decorative feature attachment for the grid; and

FIG. 8 is a partial exploded perspective view showing an alternative embodiment of rail attachment for the grid.

### DETAILED DESCRIPTION OF THE PREFERRED EMBODIMENT

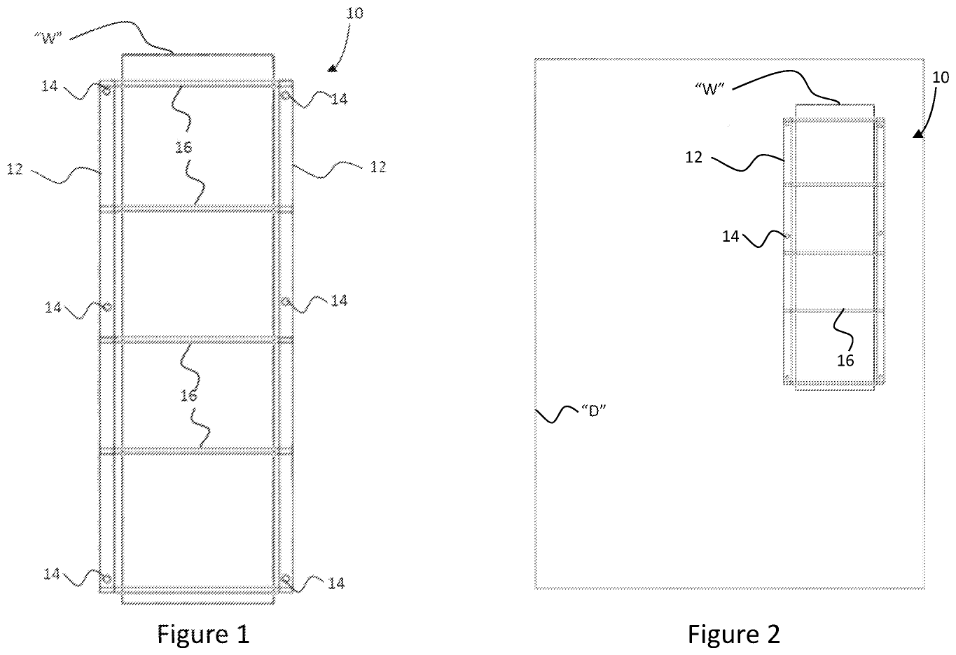

Referring now to the figures, FIGS. 1 and 2 show a window security grid 10 installed on a window “W”. The security grid 10 is secured to a door “D” by two mounting plates 12 on opposite sides of the window “W”. These mounting plates 12 can be secured on a classroom facing side of the door “D” or on an outside facing side of the door “D”. Each mounting plate 12 is attached to the door by fasteners through preformed holes 14. A series of lateral rails 16 span the distance between the mounting plates 12 across the window “W” to form a grid. These rails 16 are attached on their opposing ends to the mounting plates 12. Spacing of the rails 16 in the preferred embodiment is such that it can serve as a deterrent for an intruder breaking the window glass and/or from an arm or weapon being able to pass through the window in the event of broken glass in the window.

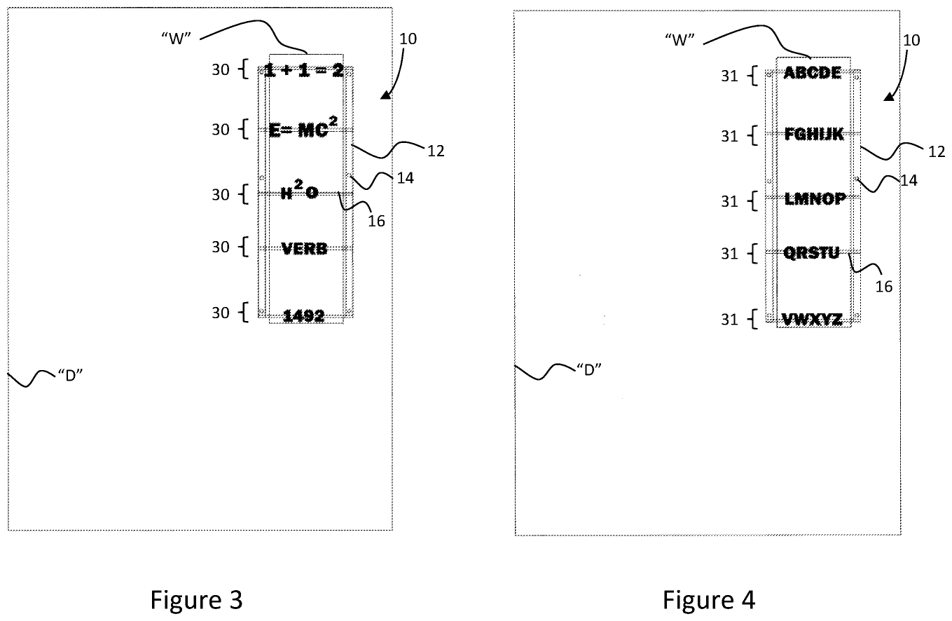

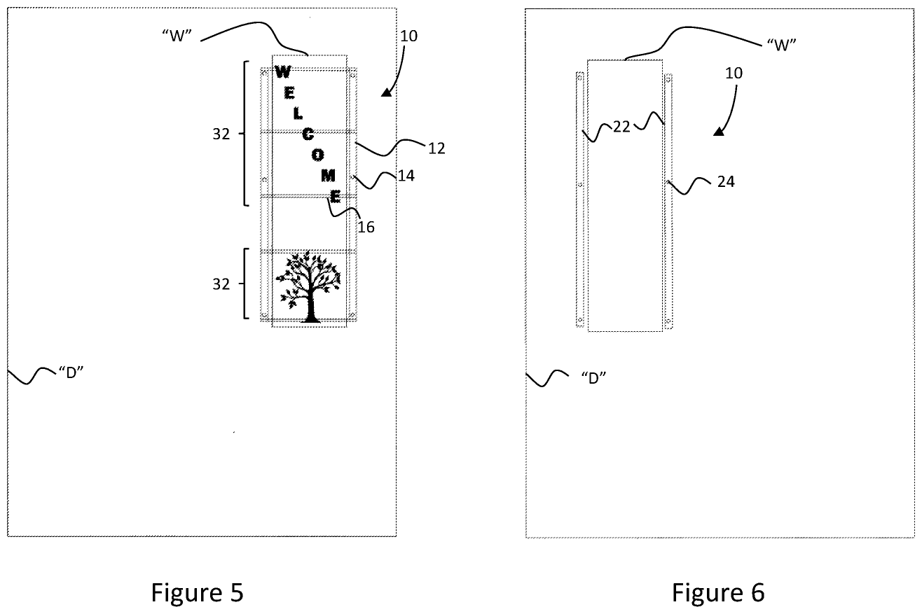

As shown in FIGS. 3-5, the rails 16 can be used to display decorative features 30, 31, 32 such as letters, numbers, math equations, pictures, or other useful/fun teaching aids. These decorative features 30, 31, 32 can be permanently or removably affixed to the rails 16.

Although the mounting plates 12 are shown mounted vertically in the figures, they can be mounted horizontally above and below the window “W” as well. The mounting plates 12 can be made of a metal, such as steel or iron, or can be made of any other suitable material. They mounting plates 12 can be flat, round, tubular, or have any other suitable cross section. In one embodiment, the mounting plates 12 have a width of between one quarter inch and six inches. In another embodiment, the depth which extends out from the wall “W” of the mounting plates 12 is less than the width. The preformed holes 14 in the mounting plates 12 can be used for the fasteners. Installation of the mounting plates 12 can require drilling into the door “D” at locations that correspond to the preformed holes 14 in order to fasten the mounting plates 12 with screws, bolts, washers, nuts, and/or any other suitable fasteners. Other methods of mounting are also envisioned, such as adhesives and brackets. The number of mounting locations per mounting plate 12 will vary based on factors such as, but not limited to, the materials used in the security grid 10, the material and depth of the door “D”, the size of the window “W”, and the type of fasteners used.

The rails 16 can be made of the same material as the mounting plates 12, or can be made of another suitable material. The rails 16 can come already connected to the mounting plates 12, for example as a single prefabricated, integrally formed, or a joined unit, or they can be attached to the mounting plates 12 prior to or during installation of the security grid 10. Examples of attachment methods are screws, bolts, snaps, adhesives, brackets, and any other suitable attachment means.

Spacing of the rails 16, in one embodiment, is between one and six inches or between one and three inches in another embodiment. Alternative embodiments of rail 16 spacing can be uniformly spaced or non-uniformly spaced. In another alternative embodiment, rails 16 can be further spaced apart closer to the top of the window “W” than the bottom of the window “W” as an intruder has less ability to access higher rails 16. One or more of the rails 16 can be adjustable in height for different functionality or for aesthetic purposes.

FIG. 6 shows an alternative embodiment of the security grid 10 where two mounting back plates 22 are secured on an opposite side of the door “D” as the mounting plates 12. The back plates 22 are located in corresponding locations to the mounting plates 12 such that mounting hardware can pass from the mounting plates 12, through the door “D”, and be secured to the back plates 22. Corresponding preformed holes 24 are located on the back plates 22. Mounting hardware can be bolts with waters and nuts. Other suitable mounting hardware such as screws and rods are envisioned.

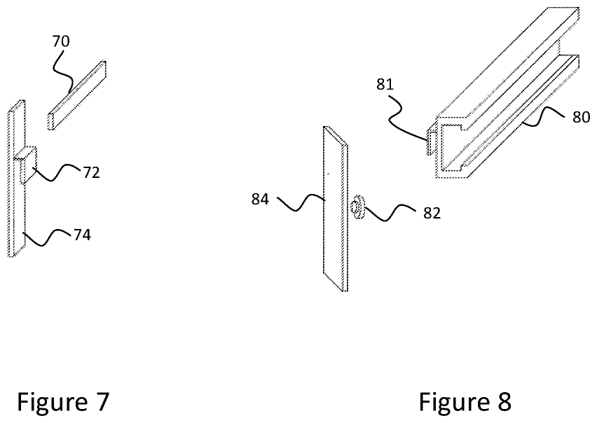

FIG. 7 shows an example of attaching a decorative feature 74 to a rail 70. The decorative feature 74 has a hook 72 on one side which is designed to fit over and be supported by the rail 70. Decorative features 74 are not limited to the hook 72 attachment method. Other attachment methods such as hook and loop, adhesives, and magnets are also envisioned.

FIG. 8 shows an example of a rail 80 that can slide in a horizontal direction for installation, customization, or height adjustment. One or more buttons 82 are located on the mounting plates 84. A hook 81 located on the rail 80 fits over and is supported by the button 82.

A window security grid according to the invention has been described with reference to specific embodiments and examples. Various details of the invention may be changed without departing from the scope of the invention. Furthermore, the foregoing description of the preferred embodiments of the invention and best mode for practicing the invention are provided for the purpose of illustration only and not for the purpose of limitation, the invention being defined by the claims.

1. A window security grid for a door having a window, comprising:
(a) two mounting plates adapted for being attached to the door on opposite adjacent sides of the window of the door;
(b) a plurality of spaced-apart security rails adapted to be attached to the two mounting plates attached to the door and extend across the window between the opposite side edges of the window; and
(c) at least one decorative feature connected to at least one of the rails.

2. The window security grid of claim 1, wherein the mounting plates are adapted to be positioned on the door and to extend along an entire length of the respective window side edges.

3. The window security grid of claim 1, further comprising a plurality of fastening members adapted to secure the mounting plates to the door.

4-6. (canceled)

7. The window security grid of claim 1, wherein the rails are adapted for being positioned in horizontally-spaced relation along a vertical extent of the window.

8. The window security grid of claim 1, wherein the rails are adapted to be adjusted along a length of the mounting plates.

9. The window security grid of claim 1, wherein at least one of the rails includes a bracket positioned on one side of the rail adapted for attachment to corresponding protruding members located on each mounting plate for connecting the rail to the mounting plates.

10. The window security grid of claim 1, wherein the decorative features are releasably attached to the rails by magnets.

11. The window security grid of claim 1, wherein the decorative features include brackets adapted to be positioned on the rails.

12. The window security grid of claim 1, further comprising:
(a) two mounting back plates adapted for being attached to the door on an opposite side with respect to the mounting plates and positioned on corresponding opposite side edges of the window; and
(b) a plurality of elongate fasteners adapted to pass through the door and secure the mounting plates to the respective back plates.

13. A window security grid comprising:
(a) first and second mounting plates adapted for being positioned on opposite side edges of a window in a door and adapted to extend along an entire length of respective side edges of the window;
(b) a plurality of spaced-apart rails oriented perpendicular to the mounting plates, adapted to span a distance between the mounting plates, and opposite ends of each rail adapted for being connected to one of the mounting plates; and
(c) a plurality of fastening members adapted to secure the mounting plates to the door through a plurality of holes in the mounting plates.

14. A window security grid comprising:
(a) a frame formed of a plurality of spaced-apart mounting plates and a plurality of spaced-apart rails oriented perpendicular to the mounting plates to collectively define the grid;
(b) the grid having width and length dimension sized to fit within the width and length dimensions of a window positioned in a door;
(c) a plurality of fastening members adapted to secure the grid to the door and over the window; and
(d) a plurality of attachment members carried by the grid for receiving decorative or informational items.

15. The window security grid of claim 14, wherein the mounting plates and rails are integrally formed.

16. The window security grid of claim 14, wherein the mounting plates and rails are individually formed for assembly to form the grid upon installation onto the door over the window.
